(19) United States
(12) Patent Application Publication
(10) Pub. No.: US 2008/0222572 A1
(43) Pub. Date: Sep. 11, 2008

(54) Look and feel of a web services mashup designer

(75) Inventors: Adam D. Nathan, Kirkland, WA (US); John I. Montgomery, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/714,312

(22) Filed: Mar. 6, 2007

(51) Int. Cl. G06F 3/048

(52) U.S. Cl. 715/855

(57) ABSTRACT

Various technologies and techniques are disclosed for providing a visual mashup designer application. A design surface is provided that displays a graphical representation in a toolbox of components that can be used to create a mashup application, at least one of the components being a wrapper to an existing web service. The visual mashup designer displays operations that each component placed on the design surface has available. A graphical mapping utility allows a user to graphically map outputs of a selected operation from a first component to inputs of a selected operation from a second component. When placed on the design surface, each component is displayed in a respective container. The respective container displays one or more operations that the respective component supports. When the user selects a particular operation for a particular component, the system displays one or more input parameters and output parameters for a particular operation.

### BACKGROUND

In modern web application development, it is possible to take output from one web application and combine it with another to create a completely new application. The result is called a “mashup”, since it is the result of the mashing together of two (or more) other web applications. To create a mashup, a developer must typically be highly sophisticated and knowledgeable in several areas, including JavaScript development, asynchronous programming practices, and extensible Markup Language (XML). Further, the developer must often devote a substantial amount of time discovering the features of any web applications that are to be part of the mashup.

### SUMMARY

Various technologies and techniques are disclosed for creating mashups using a visual mashup designer application. The system can interact with a mashup component wrapper creation process to create a wrapper for a selected web service or web site. A design surface is provided that displays a graphical representation of components that can be used to create a mashup application, including the wrapper created during the wrapper creation process. In one implementation, the graphical representation of components is shown in a toolbox of components. The system automatically generates source code when a component is added to the design surface. The code created contains the logic for which operations can be called in a respective underlying web service or web site and what parameters the operations take. The visual mashup designer displays operations that each component placed on the design surface has available. For example, using a graphical mapping utility in the designer, the user can select operations to invoke in a first component and a second component, and can then map an output of an operation of the first component to an input of an operation of the second component. The mappings can be repeated for additional components as appropriate to create a resulting mashup application.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one implementation.

FIG. 2 is a diagrammatic view of a visual mashup designer application of one implementation operating on the computer system of FIG. 1.

FIG. 3 is a high-level process flow diagram for one implementation of the system of FIG. 1.

FIG. 4 is a process flow diagram for one implementation of the system of FIG. 1 illustrating the detailed stages involved in mapping inputs from one component into outputs of another component.

FIG. 5 is a process flow diagram for one implementation of the system of FIG. 1 illustrating the stages involved in graphically representing each component and allowing mapping to be performed graphically between components.

FIG. 6 is a process flow diagram for one implementation of the system of FIG. 1 illustrating the stages involved in representing operations for each component graphically.

FIG. 7 is a process flow diagram for one implementation of the system of FIG. 1 illustrating the stages involved in programmatically creating source code when the component is placed on the design surface and when the mapping is completed.

FIG. 8 is a simulated screen for one implementation that illustrates placing wrapper components onto a design surface of a visual mashup designer application.

FIG. 9 is a simulated screen for one implementation that a more detailed view of the component mapping process and the way the s are represented and mapped graphically in the visual mashup designer.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as a visual designer application that allows for creation of web site mashups, but the system also serves other purposes in addition to these. In one implementation, one or more of the techniques described herein can be implemented as features within an application development program such as MICROSOFT® VISUAL STUDIO®, or from any other type of program or service that allows for web application development. In another implementation, one or more of the techniques described herein are implemented as features with any other applications allow a developer to create web site mashups.

In one implementation, the system provides a visual mashup designer application that allows a user to graphically create mashups of different web services and/or web sites. The system interacts with a wrapper creation process that provides a standard mechanism for converting the output of a web service and/or web site into a wrapper written in JavaScript or another dynamic language. The wrapper can be used in the visual mashup designer. The wrapper provides an interface on top of the web service that abstracts the underlying application so that the developer can interact with the wrapper rather than the underlying application. The wrapper is displayed in a toolbox or other area of the visual mashup designer along with other components (that may or may not have been created using the wrapper creation process) so the user can then create web services mashups using a visual tool. The visual mashup designer allows the user to drag and drop components onto a design surface, and then graphically map their inputs and outputs together to form the mashup. In this fashion, the user is able to graphically take multiple web services and/or web sites and link them together into a totally new application using graphical tools, and often without being required to write any lines of code.

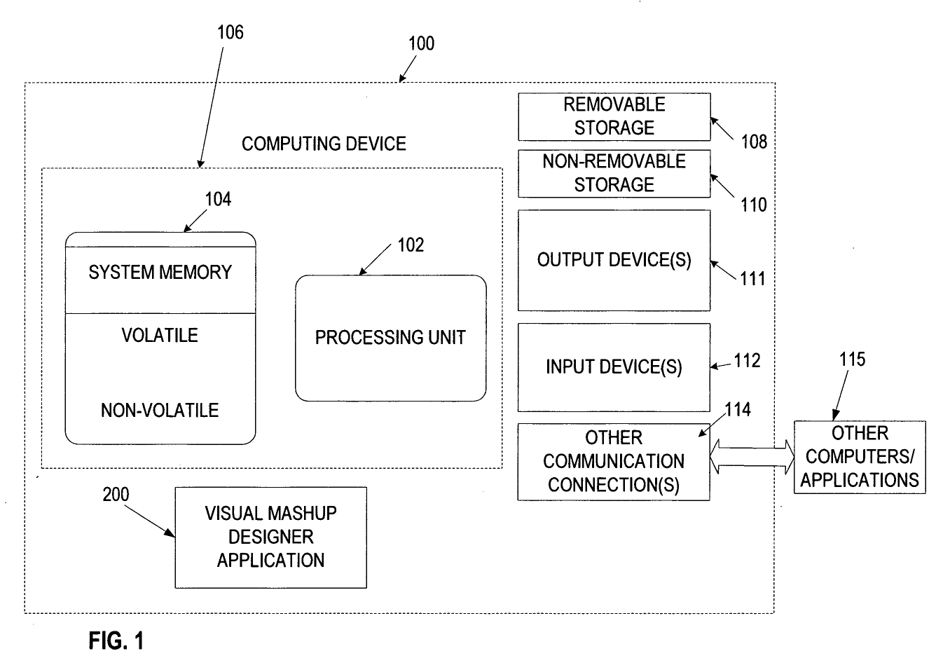

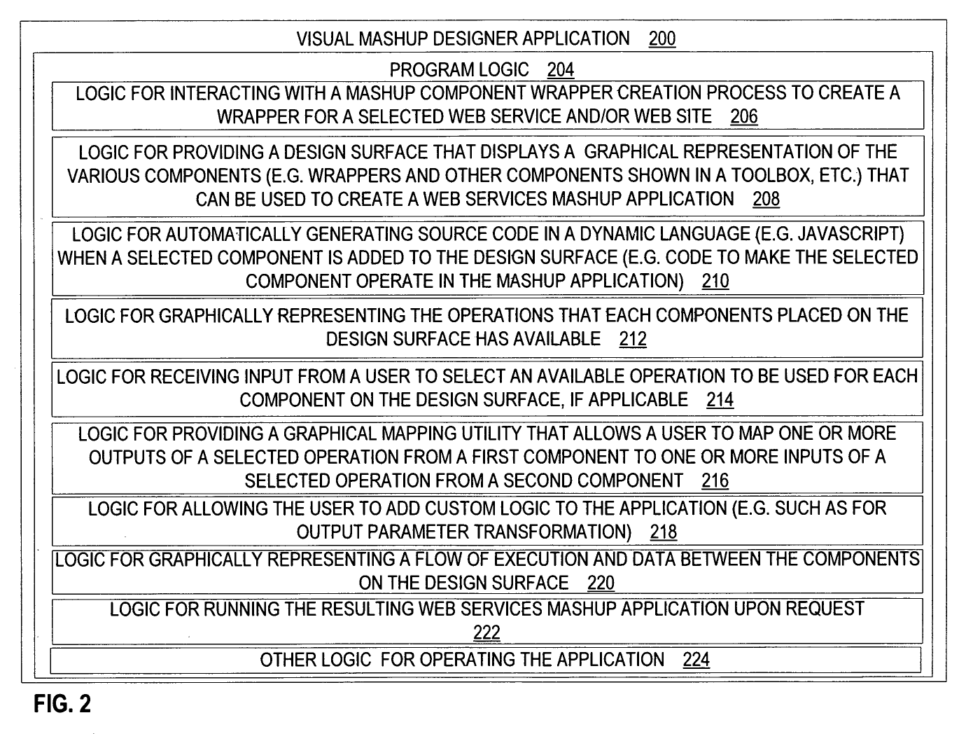

As shown in FIG. 1, an exemplary computer system to use for implementing one or more parts of the system includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 2 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

Computing device 100 includes one or more communication connections 114 that allow computing device 100 to communicate with other computers/applications 115. Device 100 may also have input device(s) 112 such as keyboard, mouse, pen, voice input device, touch input device, etc. Output device(s) 111 such as a display, speakers, printer, etc. may also be included. These devices are well known in the art and need not be discussed at length here. In one implementation, computing device 100 includes visual mashup designer application 200. Visual mashup designer application 200 will be described in further detail in FIG. 2.

Turning now to FIG. 2 with continued reference to FIG. 1, a visual mashup designer application 200 operating on computing device 100 is illustrated. Visual mashup designer application 200 is one of the application programs that reside on computing device 100. However, it will be understood that visual mashup designer application 200 can alternatively or additionally be embodied as computer-executable instructions on one or more computers and/or in different variations than shown on FIG. 1. Alternatively or additionally, one or more parts of visual mashup designer application 200 can be part of system memory 104, on other computers and/or applications 115, or other such variations as would occur to one in the computer software art.

Visual mashup designer application 200 includes program logic 204, which is responsible for carrying out some or all of the techniques described herein. Program logic 204 includes logic for interacting with a mashup component wrapper creation process to create a wrapper for a selected web service and/or web site 206; logic for providing a design surface that displays a graphical representation of the various components (e.g. wrappers and other components shown in a toolbox, etc.) that can be used to create a web service mashup application 208; logic for automatically generating source code in a dynamic language (e.g. JavaScript) when a selected component is added to the design surface (e.g. code to make the selected component operate in the mashup application) 210; logic for graphically representing the operations that each components placed on the design surface has available 212; logic for receiving input from a user to select an available operation to be used for each component of the design surface, if applicable 214; logic for providing a graphical mapping utility that allows a user to map one or more outputs of a selected operation from a first component to one or more inputs of a selected operation from a second component 216; logic for allowing the user to add custom logic to the application (e.g. such as for output parameter transformation) 218; logic for graphically representing a flow of execution and data between the components of the design surface 220; logic for running the resulting web services mashup application upon request 222; and other logic for operating the application 224. In one implementation, program logic 204 is operable to be called programmatically from another program, such as using a single call to a procedure in program logic 204.

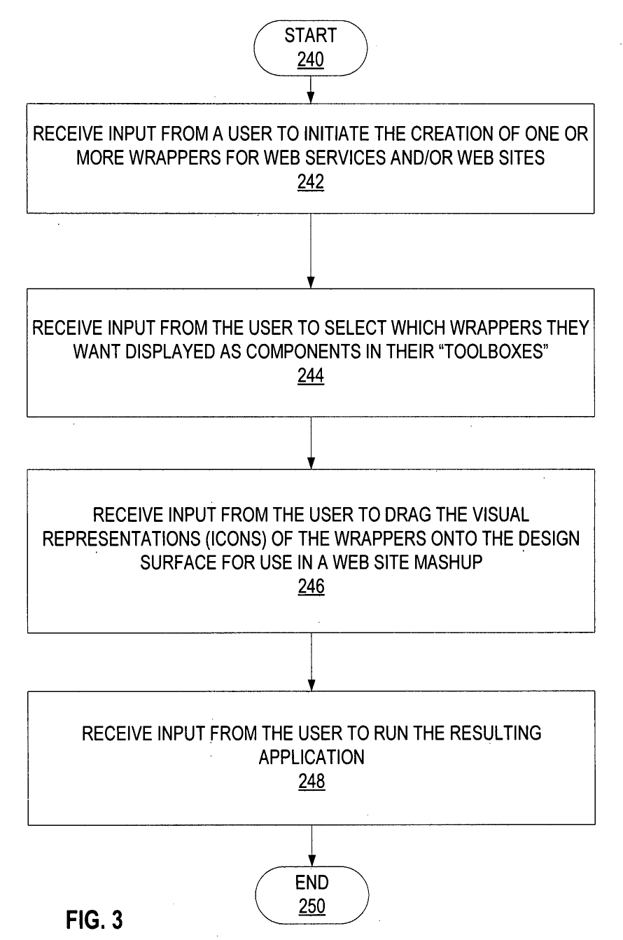

Turning now to FIGS. 3-8 with continued reference to FIGS. 1-2, the stages for implementing one or more implementations of visual mashup designer application 200 are described in further detail. FIG. 3 is a high level process flow diagram for visual mashup designer application 200. In one form, the process of FIG. 3 is at least partially implemented in the operating logic of computing device 100. The process begins at start point 240 with receiving input from the user to initiate the creation of one or more wrappers for web services and/or web sites using a mashup component wrapper application (stage 242). The system receives input from the user to select which wrappers to include in as components in a “toolbox” in visual mashup designer application 200 (stage 244). The system receives input from the user to drag the visual representations (icons) of the wrapper from the toolbox onto a designer surface of the visual mashup designer application 200 (stage 246). The wrapper is operable to respond to visual mashup designer events (stage 248). The user runs the resulting mashup application (stage 250). The process ends at end point 252.

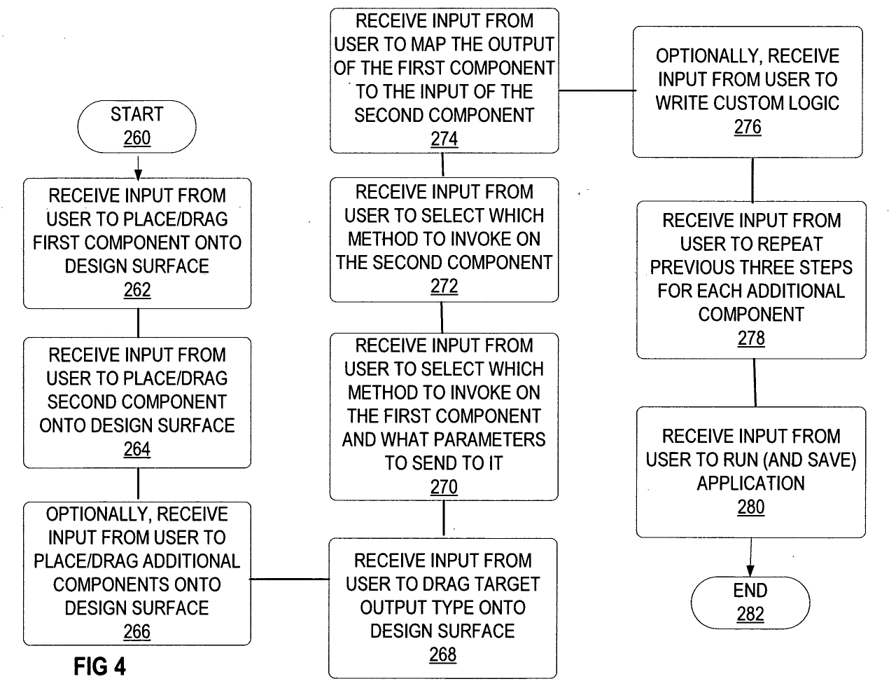

FIG. 4 illustrates one implementation of the stages involved in mapping inputs from one component into outputs of another component. In one form, the process of FIG. 4 is at least partially implemented in the operating logic of computing device 100. The process begins at start point 260 with receiving input from a user to place/drag the first component onto the design surface (stage 262). Input is received from the user to place/drag a second component onto the design surface (stage 264). Input is optionally received from the user to place/drag additional components onto the design surface (stage 266). The system receives input from the user to drag a target output type onto the design surface (stage 268). The system receives input from the user to select which method to invoke on the first component and what parameters to send it to (stage 270). Input is then received from the user to select which method to invoke on the second component (stage 272). The system receives input from the user to map the output of the first component to the input of the second component (stage 274). Optionally, input is received from the user to write custom logic (stage 276). One non-limiting example of why the user may write custom logic is to perform output parameter transformations to get the parameter of one component into a format that another component accepts. The user repeats the previous three steps for each additional component to include in the mashup application (stage 278). Input is received from a user to run (and save) the application and the resulting mashup application is displayed to the user (stage 280). The process ends at end point 282.

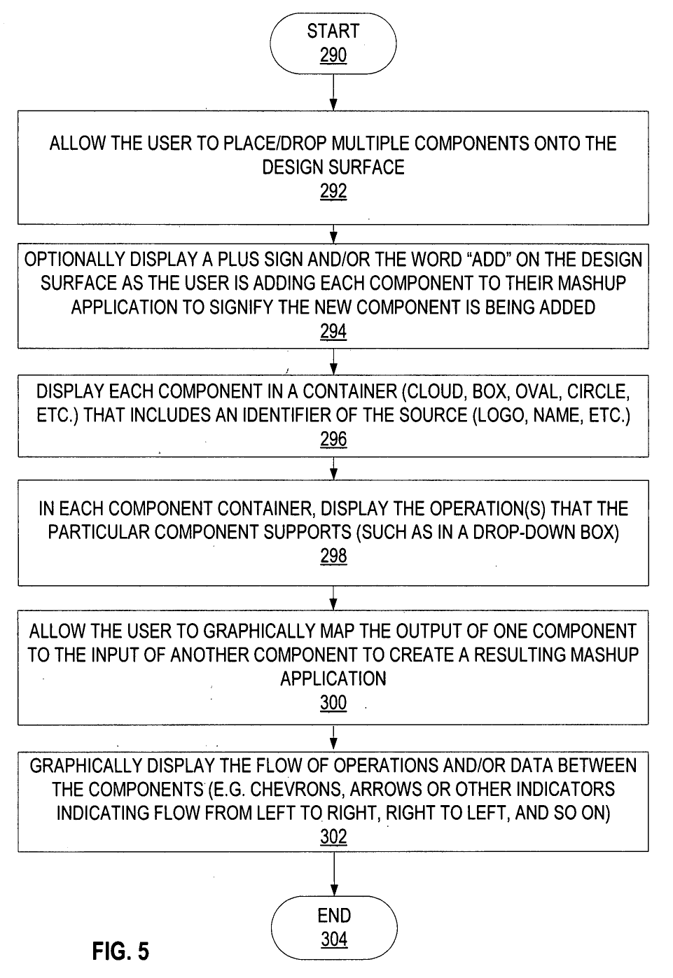

FIG. 5 illustrates one implementation of the stages involved in graphically representing each component and allowing mapping to be performed graphically between components. In one form, the process of FIG. 5 is at least partially implemented in the operating logic of computing device 100. The process begins at start point 290 with allowing the user to place/drop multiple components onto the design surface (stage 292). A plus sign and/or the word “add” is optionally displayed on the design surface as the user is adding each component to their mashup application to signify the new component is being added (stage 294). Each component is displayed in a container (cloud, box, oval, circle, etc.) that includes an identifier of the source (logo, name, etc.) (stage 296). In each component container, the operation(s) that the particular component supports are also displayed (such as in a drop-down box) (stage298). The user is able to graphically map the output of one component to the input of another component to create a resulting mashup application (stage 300). The flow of operations and/or data between the components is graphically indicated (e.g. chevrons, arrows, or other indicators indicating flow from left to right, right to left, and so on) (stage 302). The process ends at end point 304.

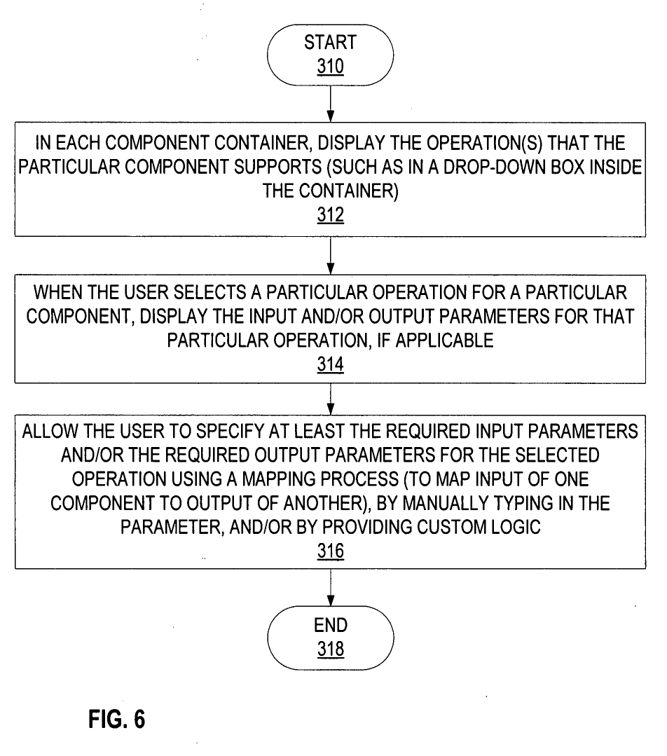

FIG. 6 illustrates one implementation of the stages involved in representing operations for each component graphically. In one form, the process of FIG. 6 is at least partially implemented in the operating logic of computing device 100. The process begins at start point 310 within each component container displaying the operation(s) that the particular component supports (such as in a drop-down box inside the container) (stage 312). When the user selects a particular operation for a particular component, display the input and/or output parameters for that particular operation, if applicable (stage 314). Allow the user to specify at least the required input parameters and/or the required output parameters for the selected operation using a mapping process (to map input of one component to output of another), by manually typing in the parameter, and/or by providing custom logic (stage 316). The process ends at end point 318.

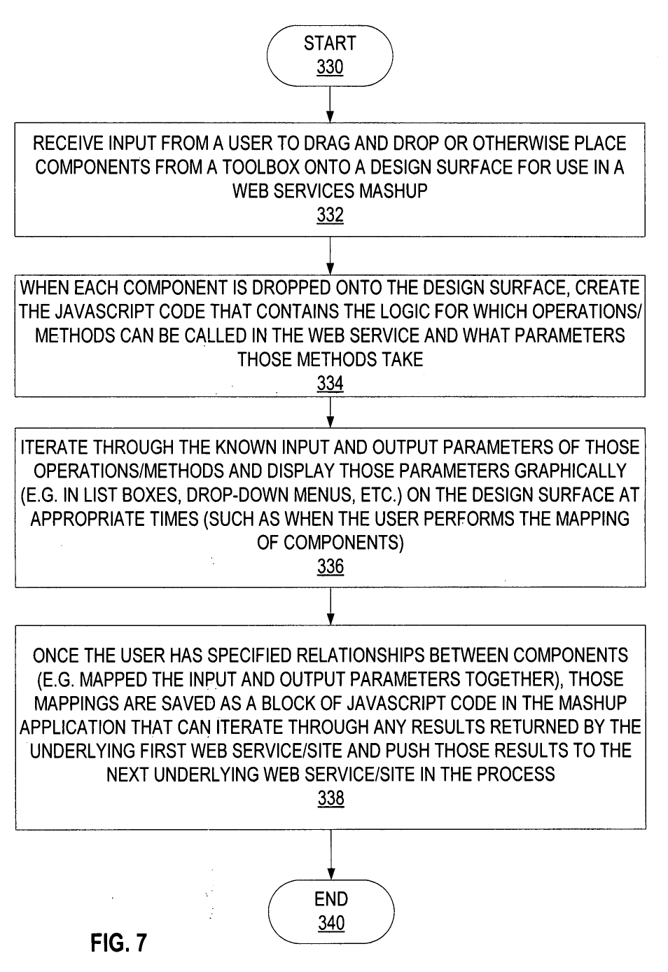

FIG. 7 illustrates one implementation of the stages involved in programmatically creating source code when the component is placed on the design surface and when the mapping is completed. In one form, the process of FIG. 7 is at least partially implemented in the operating logic of computing device 100. The process begins at start point 330 with receiving input from a user to drag and drop or otherwise place components from a toolbox onto a design surface for use in a web services mashup (stage 332). When each component is dropped onto the design surface, the system programmatically creates the JavaScript (or other dynamic language) source code that contains the logic for which operations/methods can be called in the web service and the parameters those methods take (stage 334). The system iterates through the known input and output parameters of those operations/methods and display those parameters graphically (e.g. in list boxes, drop-down menus, etc.) on the design surface at appropriate times (such as when the user performs the mapping of components) (stage 336). Once the user has specified relationships between components (e.g. mapped the input and output parameters together), those mappings are saved as a block of JavaScript (or other dynamic language) code in the mashup application that can iterate through any results returned by the underlying first web service/site and push those results to the next underlying web service/site in the process (stage 338). The process ends at end point 340.

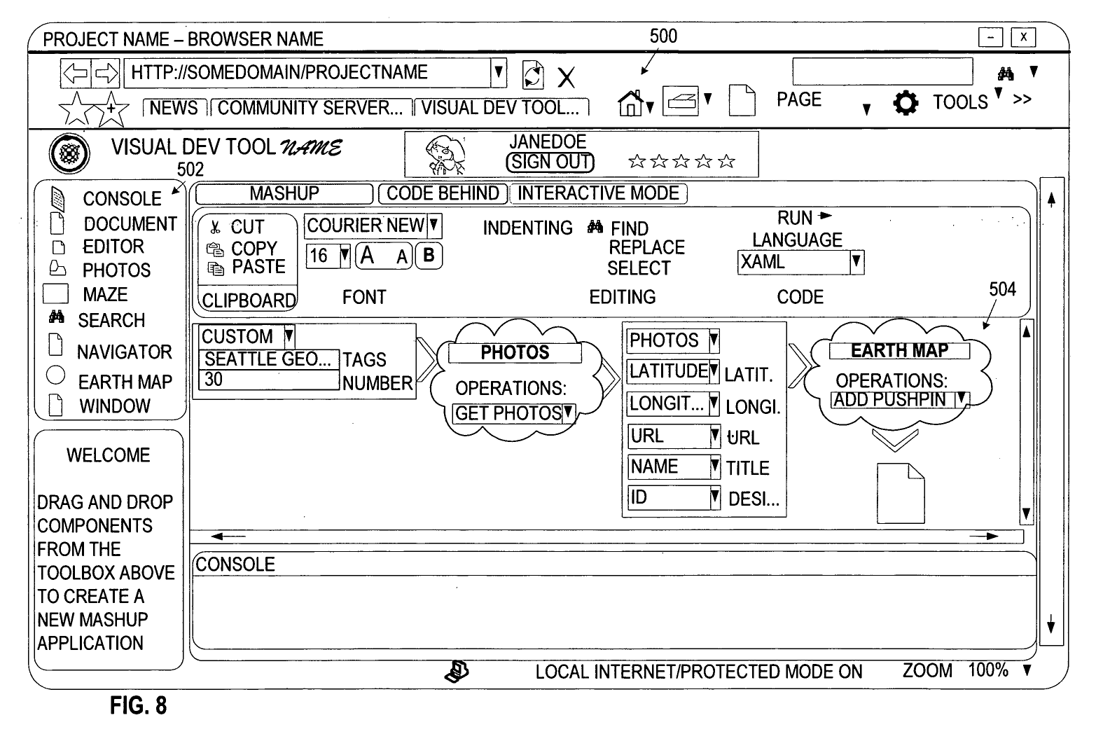

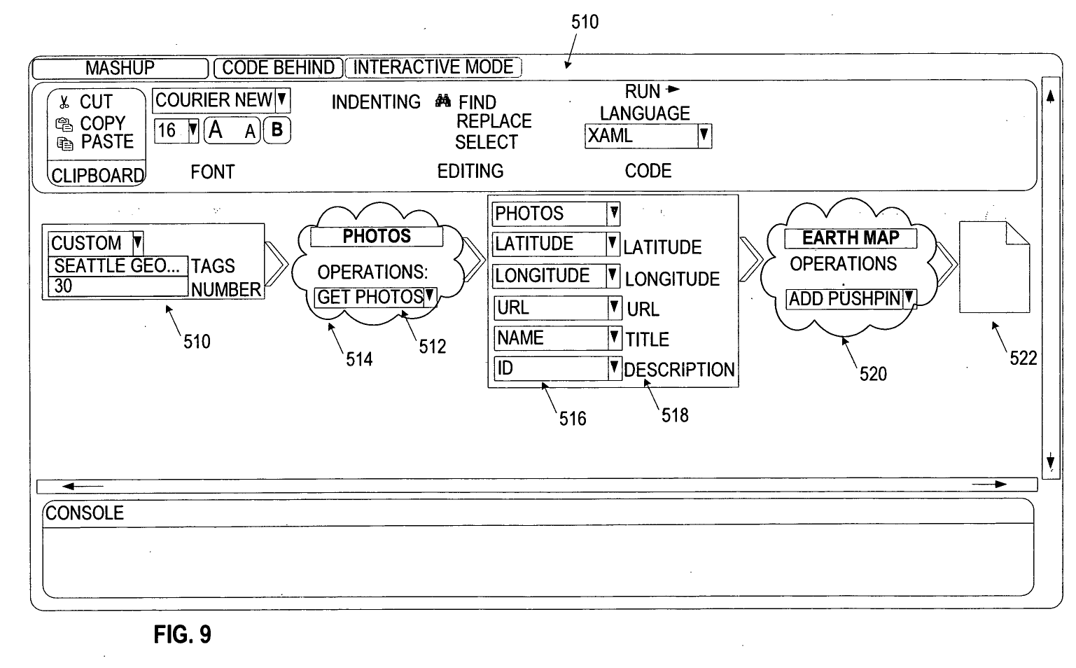

Turning now to FIGS. 8-9, simulated screens are shown to illustrate visual mashup designer application 200 in further detail. As shown in the simulated screen 500 of FIG. 9, web site wrappers and/or other components are displayed as in a toolbox 502. The user can drop any of the components in the toolbox 502 onto the design surface 504 for use in creating web site mashups. The simulated screen 510 of FIG. 9 is a more detailed view of the design surface (504 on FIG. 8) that illustrates mapping multiple components together graphically for use in a web service mashup. The design surface includes custom input parameters 510 that were specified. Those custom input parameters are being fed to the “photos” component 514, which was dragged and dropped from the toolbox (502 on FIG. 8). The user has selected the “get photos” operation 512 from the photos component 514. That operation will receive the custom parameters 510 specified by the user, and will then return various parameters as output. The output parameters 516 of the “get photos” operation 512 of the photos component 514 has been mapped by the user to input parameters 518 to the “add pushpin” operation of the earth map component 520.

The end result is then displayed in the resulting web service mashup application, represented graphically as document icon 522. In the hypothetical example depicted in FIGS. 8 and 9, when the user actually runs the resulting web service mashup application using the visual mashup designer application, photos of Seattle, Wash., are displayed along with satellite images of Seattle, Wash. These were retrieved from the underlying web services or web sites that are behind the “photos” component 514 and the “earth map” component 520 using the input and output parameters specified.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples.

What is claimed is:

1. A computer-readable medium having computer-executable instructions for causing a computer to perform steps comprising:
provide a design surface that displays a graphical representation in a toolbox of a plurality of components that can be used to create a mashup application, at least one of the components being a wrapper to an existing web service created during a wrapper creation process;
graphically represent one or more operations that each component placed on the design surface has available; and
provide a graphical mapping utility that allows a user to graphically map one or more outputs of a selected operation from a first component of the plurality of components to one or more inputs of a selected operation from a second component of the plurality of components.

2. The computer-readable medium of claim 1, wherein the computer-readable medium further has computer-executable instructions for causing a computer to perform the step comprising:
graphically represent a flow of execution between the components on the design surface.

3. The computer-readable medium of claim 1, wherein the computer-readable medium further has computer-executable instructions for causing a computer to perform the step comprising:
graphically represent a flow of data between the components on the design surface.

4. The computer-readable medium of claim 1, wherein the source code is generated using a dynamic language.

5. The computer-readable medium of claim 4, wherein the dynamic language is JavaScript.

6. A method for providing a visual mashup designer for creating a mashup application comprising the steps of:
receiving input from a user to place a plurality of components onto a design surface of a visual mashup designer;
displaying each of the plurality of components in a respective container, each respective container displaying one or more operations that a respective component of the plurality of components supports; and
displaying a graphical mapping utility that allows the user to graphically map an output of a first component of the plurality of components to an input of another component of the plurality of components to create a resulting mashup application.

7. The method of claim 6, wherein a flow of operations is displayed between the components.

8. The method of claim 6, wherein each respective container is displayed in a format selected from the group consisting of a cloud, box, oval, and circle.

9. The method of claim 6, wherein each respective container is displayed with an identifier of a source of the respective component.

10. The method of claim 9, wherein the identifier is a logo for the respective component.

11. The method of claim 9, wherein the identifier is a name for the respective component.

12. The method of claim 6, wherein at least some of the one or more operations for each respective component are displayed in a drop-down box.

13. The method of claim 6, wherein at least some of the one or more operations for each respective component are displayed in a list box.

14. The method of claim 6, wherein a plus sign is displayed as each of the plurality of components is placed onto the design surface.

15. The method of claim 6, wherein an add phrase is displayed as each of the plurality of components is placed onto the design surface.

16. A computer-readable medium having computer-executable instructions for causing a computer to perform the steps recited in claim 6.

17. A method for graphically representing operations supported by a particular web services mashup component comprising the steps of:
receiving input from a user to place a particular component onto a design surface of a visual mashup designer, the particular component being a wrapper to an existing web service;
displaying one or more operations that the particular component supports; and
displaying one or more input parameters and output parameters for a particular operation when the user selects the particular operation.

18. The method of claim 17, wherein the one or more operations are displayed in a component container of the particular component.

19. The method of claim 17, wherein the one or more operations are displayed in one or more drop-down boxes.

20. A computer-readable medium having computer-executable instructions for causing a computer to perform the steps recited in claim 17.
